(19) United States
(12) Patent Application Publication
(10) Pub. No.: US 2009/0067346 A1
(43) Pub. Date: Mar. 12, 2009

(54) METHOD, APPARATUS, AND SYSTEM FOR CONTROLLING NETWORK ENTRY OF PORTABLE INTERNET TERMINAL, AND PORTABLE INTERNET TERMINAL

(75) Inventor: Ki-Young Sung, Seoul (KR)

Correspondence Address: AMPACC LAW GROUP, 13024 Beverly Park Road, Suite 205, Mukilteo, WA, 98275, US

(73) Assignee: POSDATA CO., LTD, SEONGNAM-SI (KR)

(21) Appl. No.: 12/298,126

(22) PCT Filed: Apr. 25, 2007
(86) PCT No.: PCT/KR2007/002025

§ 371 Date: Oct. 22, 2008

(30) Foreign Application Priority Data
Apr. 25, 2006 (KR) 10-2006-0037316

(51) Int. Cl. H04W 48/08

(52) U.S. Cl. 370/254

(57) ABSTRACT

Disclosed is controlling entry of a portable internet terminal into a network, in which provided is a method and a system for processing a network entry request received from a portable internet terminal, and then controlling a network entry operation of the portable internet terminal, and is the portable internet terminal. The method includes the steps of: receiving an network entry request for entry into a portable internet network from the portable internet terminal; determining if the portable internet terminal can enter the portable internet network in response to the network entry request; and generating a network entry restriction message according to an entry restriction type in a case where the portable internet terminal cannot entry the portable internet network as a result of the determining, and transmitting the network entry restriction message to the portable internet terminal to be set a network entry operation rule by the portable internet terminal. The overall configuration of network entry control that is not being defined in portable internet standards is proposed, and load of all portable internet system can be reduced since a continuous entry attempt of a portable internet terminal corresponding to a network entry restriction type is prevented.

### TECHNICAL FIELD

The present invention relates to controlling network entry of a portable internet terminal, and more particularly to a method and an apparatus for processing a network entry request received from a portable internet terminal, thereby controlling a network entry operation of the portable internet terminal, and to the portable internet terminal.

### BACKGROUND ART

A portable internet service also called a 3.5^{th} generation (3.5G) mobile communication service is the next generation wireless data communication service having the advantages of a wireless internet service (the third generation mobile communications) based on Wideband-Code Division Multiple Access (W-CDMA), CDMA 2000, etc., as well as the advantages of a very high-speed internet service offered through a wire network.

A portable internet service based on Orthogonal Frequency Division Multiple Access (OFDMA) using a transmission bandwidth of a total of 100 [MHz] in the frequency band of 1.9 to 3.0 [GHz] is differentiated from the prior wireless internet services in that the portable internet service supports stable data transmission at the data transfer rate of more than 1 [Mbps], even in a case of being in motion at a speed of 60 [km/h]. On this account, it is expected that a simultaneous offer of various kinds of services and a service offer of Audio-on-Demand (AoD), Video-on-Demand (VoD), and the like, according to real-time multimedia data transmission, will be possible.

Like the existing wireless internet services, the portable internet services also are provided with subscriber-based services. Thus, after a user of the portable internet services has completed a subscriber registration process provided by a service provider, the user can enter a portable internet network, thereby being able to use the services.

FIG. 1 is a configuration view illustrating a broad configuration of a portable internet network. As shown in FIG. 1, the portable internet network comprises a portable internet terminal 105, a base station 104, a control station 103, a policy server 101, and an authentication server 102. Herein, the base station 104 is connected with the portable internet terminal 105 through a wireless channel. The control station 103 controls an operation of each base station 104, and connects the base station 104 to an edge router of a subscriber network. The policy server 101 manages quality policies of the base station 104 and control station 103. The authentication server 102 performs authentication related to a subscriber for the portable internet service.

For reference, the “authentication server” mentioned as a configuration element of the portable internet network in the present description is the general terms for a server that performs at least one among authentication, authorization, accounting, and other operations similar to or equivalent to any of these features. The “authentication server” is also called an AAA server, where “AAA” corresponds to initial letters of Authentication, Authorization, and Accounting, respectively.

In order to be offered the portable internet services, the portable internet terminal 105 requests entry into the portable internet network. The network entry request is delivered to the authentication server 102 via the base station 104 and the control station 103. Then, the authentication server 102 can acquire, in the Privacy Key Management (PKM) authentication step, authentication information of the portable internet terminal 105 that tries to enter the network. Namely, it can be checked if the portable internet terminal has been registered and if a terminal as a prepayment type terminal holds the prepayment deposit balance, etc. In this process, the entry of an unenrolled terminal or the entry of the prepayment type terminal having the exhausted deposit balance into the network is shut off.

However, in regard to this, IEEE 802.16d/e OFDMA standards prescribe only a process for shutting off network entry, and do not provide an operation of the portable internet terminal 105 in this case, so that it cannot be prevented to the roots that a user whose network entry is shut off (hereinafter, referred to as an “illegal user”) continues to attempt to enter the network.

In a case where the network entry continues to be attempted by the illegal user, it goes without saying that portable internet traffic increases, and a system unnecessarily comes to consume time in determining if the network entry should be shut off. These results invoke a load increase of a system, and since there are many cases where the entry into the network is continuously attempted in a systematic way with several terminals, particularly, in a case of the illegal user having a malevolent purpose, the system load is so significantly increased that handling of the network entry of a legitimate user may not be harmoniously implemented.

Also, in a case where a collision between the same Media Access Control (MAC) addresses occurs while an illegal terminal having the same MAC address as a MAC address of the legitimate user's terminal in a way of terminal duplicate, etc., tries to enter into the network simultaneously with the legitimate user's terminal, there is a problem such that the legitimate user's network entry can be unreasonably restricted.

The above problems also exist in the prior digital mobile communication services of a CDMA scheme and in the wireless internet services based on the prior digital mobile communication services of the CDMA scheme. Still, a method for controlling a terminal in order to settle the above problems has been already applied to a portable communication system of the CDMA scheme.

In the mobile communication system of the CDMA scheme, if a terminal receives a normal paging channel message after the terminal is powered on, the terminal performs registration after about 20[seconds]. At this time, in a case where information of the CDMA terminal, e.g., a Mobile Identification Number (MIN), an Electronic Serial Number (ESN), or Authentication Key (A_Key), etc., are not registered, the system shuts off the network entry of the terminal, and stops an operation of the terminal for 48[hours] till before the terminal is powered on again.

Furthermore, if the network entry of the terminal is attempted after a power button is pressed in the terminal, the system refers to a system registration status. If the terminal is an unregistered terminal, the system transmits a command message to the un-registered terminal though a traffic channel to simply stop the function of the terminal, thereby preventing the terminal from attempting to the network entry.

Because even simple network entry request processing techniques that are already being applied to the CDMA network are not reflected in standards related to the portable internet at all, if a portable internet system is constructed according to the standards, a special plan is necessary to settle the aforementioned problems. Moreover, the CDMA network supports only the network entry control of an unauthenticated terminal, and cannot support traffic load balancing occurred when multiple subscribers in a specific cell try to call at the same time.

Hereupon, in the present invention, a proposal will be made on new technology for controlling network entry of a portable internet terminal by the system end and the terminal end in order to settle the above problems in a portable internet system.

### DISCLOSURE OF INVENTION

### Technical Problem

Accordingly, the present invention has been made to solve the above problems occurring in the prior art, and it is an aspect of the present invention to provide a detailed configuration of an apparatus and a system for controlling network entry of a portable internet terminal in the portable internet network system end to complement an IEEE 802.16d/e standards that do not prescribe a method for shutting off network entry embodied by the terminal end.

It is another aspect of the present invention to provide effective control over network entry without modifying IEEE 802.16d/e standards by setting and referring to a flag value according to an authentication result of the portable internet terminal end.

In further detail, it is another aspect of the present invention to provide a reduction in a system load caused by preventing network entry continuously attempted by an un-registered user in addition to primarily shutting off network entry by the unregistered user to supply a legitimate user with faster and harmonious network entry processing.

Also, it is another aspect of the present invention to provide a reduction in load of all system, caused by preventing a repetitive network entry request of a portable internet terminal whose prepayment has been exhausted.

Furthermore, it is another aspect of the present invention to provide improving the processing efficiency of a system by restricting the network entry and by preventing an attempt to do a continuous network entry thoroughly in a case where MAC addresses assigned to different portable internet terminals collided.

It is a further aspect of the present invention to provide preventing the occurrence of traffic overload in a specific cell from affecting an overall system in such a way that an attempt of a network entry through the specific cell is limited, and a message for reflecting the occurrence of traffic overload in the terminal side is forwarded.

It is a still further aspect of the present invention to provide preventing inconvenience to an owner of a lost terminal due to the illegal use of a person who has found and used the lost terminal by obviating an attempt to enter a network by a portable internet terminal that has been reported as a lost article, and also provide easy handling of the loss of the terminal and raising the recovery of lost terminals by managing, by the server side, information on a position related to the relevant lost terminal, the number of times entry into a network has been tried, base station information of a cell to which the terminal connects, etc.

It is a yet further aspect of the present invention to provide a configuration of a terminal equipped with the function of determining a network entry operation according to a received control message on receiving the control message related to the control over the network entry control from the server side.

It is a still yet further aspect of the present invention to provide a detailed proposal for a configuration and an operation of a network entry control system including a portable internet terminal, a base station, a control station, and an authentication server.

### Technical Solution

In order to accomplish the above-mentioned aspects of the present invention and to settle the above-mentioned problems occurring in the prior art, there is provided a method for controlling entry of a portable internet terminal into a portable internet network according to an embodiment of the present invention, including the steps of: receiving an network entry request for entry into the portable internet network from the portable internet terminal; determining if the portable internet terminal can enter the portable internet network in response to the network entry request; and generating a network entry restriction message according to an entry restriction type in a case where the portable internet terminal cannot entry the portable internet network as a result of the determining, and transmitting the network entry restriction message to the portable internet terminal to be set a network entry operation rule by the portable internet terminal.

Also, there is provided an apparatus for controlling entry of a portable internet terminal into a portable internet network, the apparatus comprising: an entry request receiving unit for receiving a network entry request from the portable internet terminal; an entry determining unit for determining if the portable internet terminal can enter the portable internet network; and a message transmission unit for generating a network entry restriction message in a case where the entry determining unit determines that the portable internet terminal cannot enter the network, and for transmitting the generated network entry restriction message to the portable internet terminal, wherein the network entry restriction message is received by the portable internet terminal, and is used in setting a network entry operation rule of the portable internet terminal.

The idea of the art in the present invention is applied even to a portable internet terminal included in a portable internet network, and in accordance with another aspect of the present invention, there is provided a portable internet terminal according to an embodiment of the present invention, including: an entry request transmission unit for transmitting a network entry request to access to a portable internet network; a type reading unit for receiving a response message containing a type identifier in responding to the network entry request, and for reading the type identifier containing a network entry restriction type of the portable network terminal; and a rule storage unit for storing a network entry operation rule corresponding to the type identifier, wherein the entry request transmission unit executes the network entry request or a network reentry request according to the network entry operation rules stored in the rule storage unit.

And, there is provided a system for controlling entry of a portable internet terminal into a portable internet network, the system comprising: a portable internet terminal, linked via the portable internet network, for accessing to a base station, a control station, and an authentication server, wherein the portable internet base station for receiving a network entry request from the portable internet terminal, and for transmitting a Media Access Control (MAC) address of the portable internet terminal to the control station; the control station for requesting the authentication server to perform authentication in regard of the portable internet terminal by using the received MAC address; and the authentication server for performing the authentication in response to the authentication performance request from the control station, wherein the base station transmits an authentication result to the portable internet terminal in a case where the authentication fails.

### Advantageous Effects

A method for controlling entry of a portable internet terminal into a portable internet network according to of the present invention can control effectively the network entry of the portable internet terminal, so that legitimate users are able to use system resources and processing time squandered in processing network entry requests of illegal users and to be offered a harmonious network entry service.

To this end, the method for controlling entry of a portable internet terminal into a portable internet network according to an embodiment of the present invention can control a network entry operation of the portable internet terminal by each entry restriction type by using an entry restriction message having entry restriction type information therein, and then, can implement more adaptive and extensible entry control.

On this account, a complement to the contents of the IEEE 802.16d/e standards that are not prescribing an operation for controlling entry of the portable internet terminal end into a network can be accomplished.

A method for controlling entry of a portable internet terminal into a portable internet network according to another embodiment of the present invention sets a flag value based on an authentication result by the portable internet terminal end, and determines if a network entry request is transmitted in reference to the flag value, which in turn can perform effective network entry control only with a configuration in the portable internet terminal end, without modifying the IEEE 802.16d/e standards.

The method for controlling entry of a portable internet terminal into a portable internet network according to the present invention reduces system load by preventing entry into the network continuously attempted by a user who has not been registered, in addition to primarily shutting off entry into a network by the unregistered user, and accordingly, can supply a legitimate user with a faster and harmonious network entry processing.

Also, the method for controlling entry of a portable internet terminal into a portable internet network according to the present invention can reduce load of all system by preventing repetitive network entry requests of a portable internet terminal whose prepayment deposit has been exhausted.

Furthermore, the method for controlling entry of a portable internet terminal into a portable internet network according to the present invention shuts off entry into the network, and prevents an attempt to continue to enter the network to the roots in a case where a collision between the same MAC addresses occurs in a MAC address assigned to each portable internet terminal, which in turn can improve the processing efficiency of a system.

What's more, the method for controlling entry of a portable internet terminal into a portable internet network according to the present invention limits an attempt to enter into the network through a specific cell, and forwards a message in order to reflect the occurrence of traffic overload in the terminal side in a case where the traffic overload in the specific cell occurs, which in turn can prevent the occurrence of the overload in the specific cell from affecting an overall system.

In addition, the method for controlling entry of a portable internet terminal into a portable internet network according to the present invention prevents inconvenience to an owner of a lost terminal due to the illegal use of a person who has found and used the lost terminal by obviating an attempt to enter a network by a portable internet terminal that has been reported as a lost article. Besides, the method facilitates easy handling of the loss of the terminal and can raise the recovery of lost terminals by managing, by the server side, information on a position related to the relevant lost terminal, the number of times entry into the network has been tried, base station information of a cell to which the terminal connects, etc.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a configuration view illustrating a broad configuration of a portable internet network according to IEEE 802.16d/e standards;

FIG. 2 is a flowchart illustrating, by steps, a method for controlling network entry according to an embodiment of the present invention;

FIG. 3 is a table illustrating the structure by fields of a network entry restriction message according to an embodiment of the present invention;

FIG. 4 is a table illustrating kinds and descriptions of types in regard to type identifiers included in a restriction message of network entry according to an embodiment of the present invention;

FIG. 5 is a block diagram illustrating an internal configuration of an apparatus for controlling network entry according to an embodiment of the present invention;

FIG. 6 is a block diagram illustrating an internal configuration of a portable internet terminal according to an embodiment of the present invention;

FIG. 7 is views illustrating each example of a user screen displayed by a display unit of a portable internet terminal according to an embodiment of FIG. 6 in the case of network entry restriction;

FIG. 8 is a block diagram illustrating an internal configuration of a portable internet terminal according to another embodiment of the present invention; and

FIG. 9 is a block diagram illustrating a configuration of a system for controlling network entry according to an embodiment of the present invention.

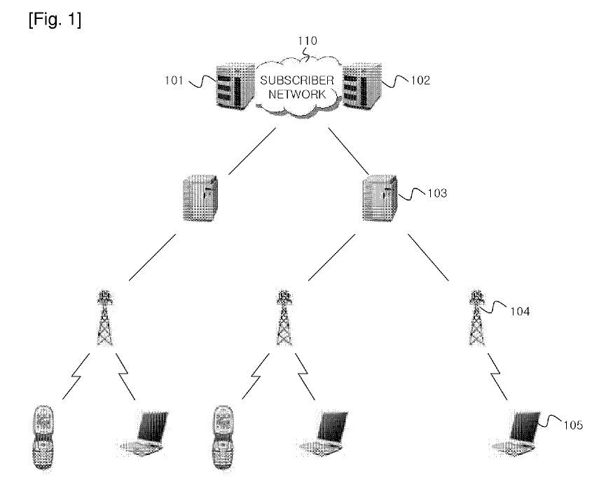

### MODE FOR THE INVENTION

Hereinafter, an exemplary embodiment of the present invention will be described in detail with reference to the accompanying drawings. Well known functions and constructions are not described in detail since they would obscure the invention in unnecessary detail.

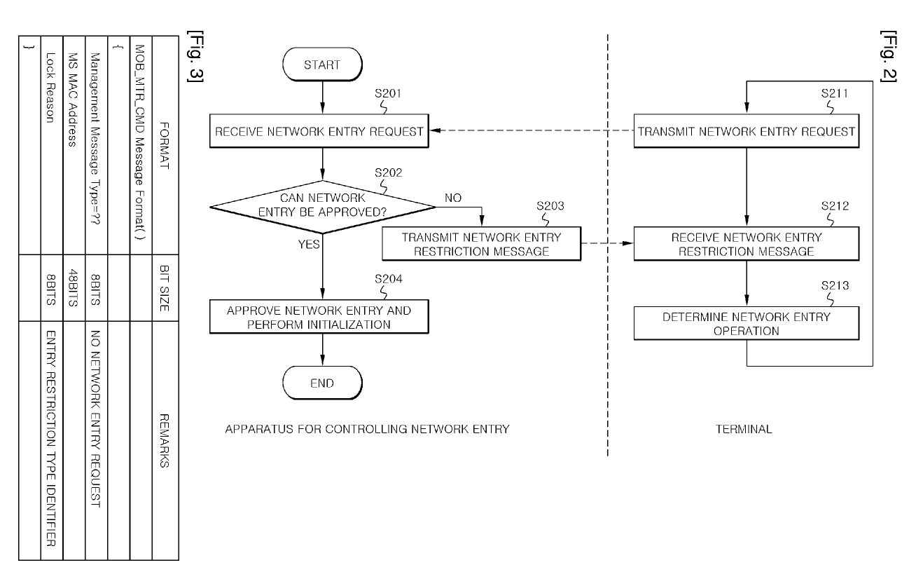

FIG. 2 is a flowchart illustrating, by steps, a method for controlling network entry according to an embodiment of the present invention.

As illustrated in FIG. 2, the method for controlling network entry according to an embodiment of the present invention from a portable internet terminal includes, receiving an entry request for entry into a portable internet network from a portable internet terminal (S201); determining if the portable internet terminal can enter the portable internet network in response to the network entry request (S202); and generating a network entry restriction message according to an entry restriction type in a case where the portable internet terminal cannot enter the portable internet network as a result of the determination in step S202, transmitting the network entry restriction message to the portable internet terminal, and setting, by portable internet terminal, a network entry operation rule (S204).

A left part in FIG. 2 represents steps performed by an apparatus for controlling network entry (hereinafter, referred to as a “control apparatus”) end. A right part therein illustrates steps performed by a portable internet terminal (hereinafter, referred to as a “terminal”) end. For reference, the apparatus for controlling network entry can be configured to include any of a base station 104 apparatus, a control station 103 apparatus, and an authentication server 102 apparatus constructing the portable internet network.

If a network entry request is transmitted from the terminal (S211) in order to be offered a specific service, the control apparatus receives the network entry request (S201), and determines if the relevant terminal can enter the network from the received request information (S202). If it is determined in step S202 that the relevant terminal can enter the network, namely, in a case where a predetermined entry restriction type is not applied, an initializing process related to the entry into the network is performed (S204).

For reference, the initializing process includes the transmission/reception of a Dynamic Service Addition REQuest (DSA_REQ) message for asking to add a portable internet service and a Dynamic Service Addition ReSPonse (DSA_RSP) message transmitted in reply to the DSA_REQ message, or the transmission/reception of a REGistration REQuest (REG_REQ) message for giving notice that the terminal has entered the portable internet network and a REGistration ReSPonse (REG_RSP) message transmitted in response to the REG_REQ message, and the like. Also, the REG_REQ message can contain information for supporting a MAC address of the terminal, an Internet Protocol (IP) management mode, and handover.

Meanwhile, if it is determined in step S202 that the relevant terminal cannot enter the network, namely, in a case where a predetermined entry restriction type is applied, a network entry restriction message, which is related to the entry restriction type and containing a type identifier being able to update, is generated, and then the network entry restriction message is transmitted to the terminal (S203).

FIG. 3 illustrates an example configured in the form of table, wherein the network entry restriction message transmitted from the control apparatus to the terminal conforms to the message form defined in the IEEE 802.16d/e standards, and the unique contents of the present invention are contained in fields of the network entry restriction message.

As illustrated in FIG. 3, when the name of the network entry restriction message is referred to as “MOB_MTR_CMD,” the message contains a management message type field, a Portable Station (MS) MAC address field, and a lock reason field. For example, the message can contain an 8-bit management message type field, a 48-bit MS MAC address field, and an 8-bit lock reason field.

The management message type field contains a predetermined code signifying the network entry restriction and the lock reason field contains a type identifier value related to an entry restriction type. In this manner, in a case where a network entry restriction message is configured according to a general message form defined in the IEEE 802.16d/e portable internet standards, compatible entry control can be embodied within the range where many modifications are not made to the configurations of the prior system and terminal.

The terminal receives the network entry restriction message (S212), and sets a network entry operation rule of the terminal with reference to a type identifier value contained in the message(S213). Herein, the network entry operation rules mean a series of rules associated with an operation of the terminal, to which the terminal refers in the step of transmitting a network entry request.

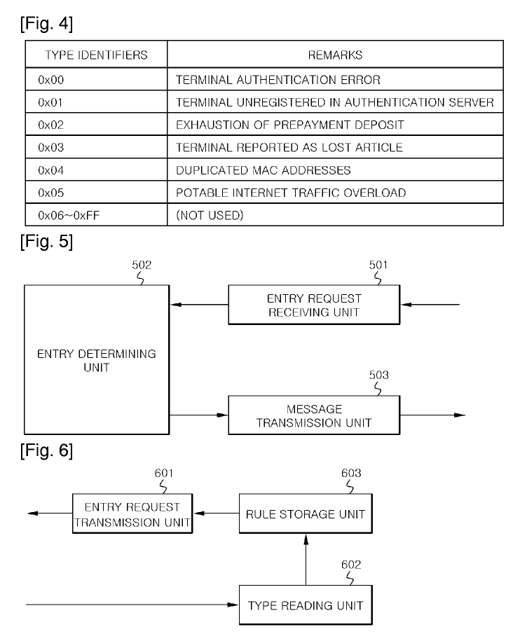

FIG. 4 is a table illustrating kinds and descriptions of types in regard to type identifiers contained in a network entry restriction message according to an embodiment of the present invention. As illustrated in FIG. 4, a type identifier value of “0×00” represents an entry restriction type related to an error caused by a failure of a process of authenticating the terminal. “0×01” represents an entry restriction type which the terminal has not been registered in an authentication server. “0×02” represents an entry restriction type related to a case where a prepayment of the terminal have to charge with a deposit for balance due to being exhausted. “0×03” represents an entry restriction type associated with a case where it is impossible for a terminal to enter the network since the terminal transmitting an entry request corresponds to a terminal that has been reported as a lost article. “0×04” represents an entry restriction type referring to a case where a collision occurs between MAC addresses in that the MAC address of a terminal transmitting an entry request is the same as that of another terminal. Lastly, “0×05” represents an entry restriction type relating to a case where network entry is not allowed due to the occurrence of portable internet traffic overload in a specific cell.

Each entry restriction type illustrated in FIG. 4 corresponds to only an example of entry restriction types that can be processed by the method for controlling network entry according to the present invention, and it is a well known to those skilled in the art that a list of entry restriction types can be configured in a way different from this. Especially, additional processing can also be implemented for more entry restriction types if type identifier values in an unused area of “0×06” to “0×FF” are used.

As previously stated, the network entry operation rules are set so that the type identifier values may cause the terminal to operate differently. To cite an instance, in a case where the entry restriction types are defined as a first type in which the authentication of the portable internet terminal is failed, a second type in which the portable internet terminal has not been registered in the authentication server of the portable internet network, a third type in which the portable internet terminal corresponds to a prepayment type terminal, and in which the prepayment deposit connected with the portable internet terminal is exhausted, a fourth type in which the portable internet terminal has been reported as a lost article, a fifth type in which the MAC addresses assigned to portable internet terminals are duplicated, and a sixth type in which a traffic of the portable internet network is overloaded in a cell to which the portable internet terminal connects, if the entry restriction type corresponds to any of the first to third types, the network entry operation rule is set to prohibit the network reentry request while the portable internet terminal is powered on. At this time, if the entry restriction type corresponds to the third type, the network entry operation is set to stop portable internet services provided to the portable internet terminal.

Also, if the entry restriction type corresponds to the fourth type or the fifth type, the network entry operation rule is set to prohibit the network reentry request while the portable internet terminal is powered on, and that to provide the apparatus for controlling network entry with at least one among identification number information of terminal contained in the network entry request, number information of base station, and information of time when a network entry request is received on.

Furthermore, if the entry restriction type corresponds to the sixth type, the network entry operation rule is set to request the network reentry after a set time passes. The set time may be arbitrarily set by telecommunication providers, and may be set to, for example, an interval of 5 minutes, 30 minutes, or 1 hour.

In addition, the network entry operation rule is set to display the message by types representing the entry restriction types of the portable internet terminal besides the aforementioned network entry operations. A detailed description will be made of this respect in an embodiment related to FIG. 7.

In this manner, the method in which the terminal side refers to the additional information on the network entry restriction types, and then controls the network entry operation of the terminal, can be a more flexible and extensible network entry control method in that a separate operation can be set in regard of each entry restriction type, and that a rule related to the operation can be updated ay any time.

The terminal refers to the network entry operation rules, and performs the operation related to the network entry. For instance, in a case where the network entry operation rule is set not to request the network entry at all, the terminal may not transmit the network entry request itself as long as special measures are not taken.

For reference, the network entry request from the terminal may contain a RaNGing REQuest (RNG_REQ) message in regard to the terminal. Herein, ranging means a series of processes for maintaining linking quality in wireless communications between a base station and a terminal in a portable internet network. Namely, prior to the network entry, a ranging process for forming a stable channel between the base station and the terminal can be not only a start point of but also a part of a process for requesting the network entry.

In the meantime, the above-stated network entry operation rules is set to prohibit the network entry request until the terminal is powered on or off, i.e., while the terminal is continuously powered on without any change in a state of power source. Namely, a continuous attempt to enter the network must be shut off in a state where the network entry has been failed as the present situation corresponds to a specific entry restriction type, but a state of the terminal and a state of the network are checked when the terminal is turned on or turned off, and then entry into the network may be attempted again.

To take an example, in a case where it is impossible to enter a network due to overload of traffic in a cell to which a portable internet terminal connects, since a network entry operation of the terminal depends on a network state that time and a place cause to change, continuity in time and space of the terminal cannot be guaranteed before the power supply is cut, and after the power supply is cut and is then supplied again. Namely, a user who carries the terminal may be moved to another cell, or traffic overload may be solved as a network state takes a favorable turn over time.

Meanwhile, according to another embodiment of the present invention, in a case where a entry restriction type corresponds to an authentication result in regard of a portable internet terminal, a network entry operation rule is set to store a flag value associated with a network entry operation according to the authentication result.

Also, in the case of the present embodiment, the apparatus for controlling network entry receives the network entry request from the terminal (S211), performs authentication related to the terminal, and takes a distinct operation according to an authentication result (S202). If the authentication is successful, an initializing process related to the network entry is performed (S204).

However, if the authentication related to the terminal fails, the control apparatus transmits an entry restriction message containing an authentication result to the terminal side (S203). Then, the terminal receives the entry restriction message (S203), and determines a network entry operation according to the authentication result (S213). Particularly, according to the present embodiment, step S213 of determining a network entry operation stores a prescribed flag value according to the authentication result, and sets a network entry operation rule.

As an example, an operation for setting the value of a flag can be performed as follows: the value of the flag is “set” if the received authentication result corresponds to an authentication failure; and the value of the flag is “reset” or is maintained as it is if the received authentication result corresponds to a successful authentication. The terminal refers to the flag value, and can determine if the next network entry request is to be transmitted. Namely, network entry operation rules is set not to transmit the next network reentry request if the flag is set to a certain value, and to transmit the network reentry request if the flag value is reset.

The present embodiment is different from an embodiment described with reference to FIG. 2 in that the present embodiment does not use the information on the network entry restriction types. On this account, it is easy to materialize the present embodiment, and implementation is made by adding required functions to the terminal within the range where modifications are not made to a given system, which in turn can accomplish satisfactory network entry control even without complementing or modifying the IEEE 802.16d/e standards.

In the present embodiment, the control apparatus may directly perform authentication of the terminal, or request a separate authentication server to perform the authentication of the terminal. Furthermore, the authentication may include security key management authentication of the terminal. Accordingly, the authentication results transmitted from the control apparatus to the terminal side may be transferred in the form of a security key authentication response (PKM_RSP: Privacy Key Management ReSPonse) message.

Until now, a description has been made of the method for controlling network entry according to the present embodiment, and because the contents associated with the network entry request and the initializing operation related to the network entry in the description of the embodiment previously mentioned with reference to FIG. 2, may be applied to the present embodiment in a like manner, a detailed description will be omitted hereinafter.

The method for controlling network entry according to the present invention is embodied in the form of program commands that can be performed through various computer means, and can be recorded in media that can be read by computers. The media that can be read by computers includes any of program commands, data files, data structures, etc., or a combination among them. The program commands recorded in the media can be specially designed and configured for the present invention. Also, the program commands may correspond to these commands that are known to all those skilled in the art of computer software, and that are then able to be used by them. Examples of the recording media that can be read by computers include hardware devices, specially configured so that the program commands may be stored and executed, including magnetic media, optical media such as Compact Disc-Read Only Memory (CD-ROM) and Digital Versatile Disc (DVD), magneto-optical media such as floptical disc, Read Only Memory (ROM), Random Access Memory (RAM), flash memory, and the like. The media may correspond to transmission media, such as light or a metallic wire, a waveguide, etc., including a carrier wave, transmitting a signal specifying a program command, a data structure, and the like. Examples of the program commands include not only machine language codes produced by a compiler but also high-level language codes that can be run by a computer by using an interpreter, and the like. Each of the above-described hardware devices can be configured so that each hardware device may operate as at least one software module in order to perform the operation of the present invention. The inverse is also alike.

The respect such that the method for controlling network entry according to present invention is performed by the apparatus for controlling network entry and the terminal has already been described. The apparatus for controlling network entry according to an embodiment of present invention comprises an entry request receiving unit, an entry determining unit, and a message transmission unit. Herein, the entry request receiving unit receives an entry request from a portable internet terminal. The entry determining unit determines, in response to the network entry request, if the portable internet terminal can enter a portable internet network. The message transmission unit transmits a network entry restriction message to the portable internet terminal in a case where the portable internet terminal corresponds to a prescribed entry restriction type, and entry into the network of the terminal is restricted.

FIG. 5 is a block diagram illustrating an internal configuration of an apparatus for controlling network entry according to an embodiment of the present invention. Referring to FIG. 5, the entry request receiving unit 501 included in the present apparatus receives the network entry request from the terminal, and delivers the received network entry request to the entry determining unit 502. The entry determining unit 502 determines if the terminal transmitting the entry request can enter the portable internet network in responding to the received network entry request.

As an example, the entry determining unit 502 selects, from the received entry request, a MAC address of the terminal, an identification number of the terminal, subscriber information, information on a base station to which the terminal connects, whether the terminal corresponds to a prepayment type terminal, whether the balance of a deposit is held, etc., and may determine, with reference to at least one of the above information, if the terminal may enter the network.

If the entry determining unit 502 determines that the terminal may not enter the network, the message transmission unit 503 transmits, to the terminal side, an entry restriction message containing a type identifier associated with an entry restriction type. The terminal sets a network entry operation rule on the basis of a type identifier value contained in the entry restriction message.

According to another embodiment of the present invention, a network entry restriction message related to an entry restriction type transmitted to the terminal side from an apparatus for controlling network entry contains an authentication result in regard of the terminal. Also, in a case where the entry restriction type corresponds to the authentication result in regard of the terminal, the terminal that has received the network entry restriction message, stores a flag value relating to a network entry operation with reference to the authentication result, and sets a network entry operation rule to prohibit a network reentry request while the terminal is powered on.

A process for authenticating the terminal, performed by the apparatus for controlling network entry according to the present embodiment, may be directly performed by the entry determining unit 502, or it may be also performed in such a way that the present apparatus receives an authentication result after transmitting an authentication performance request to a separate authentication server.

If the authentication result corresponds to an authentication failure, a message transmission unit 503 transmits the authentication result to the terminal side in the form of security key authentication response message. Since the security key authentication response message has already been defined in the IEEE 802.16d/e standards, the apparatus for controlling network entry according to the present embodiment can produce the realization of network entry control only by applying a change to a configuration of the terminal end without the need to modify or complement the IEEE 802.16d/e standards.

The preset invention is also applied to a portable internet terminal included in a portable internet network.

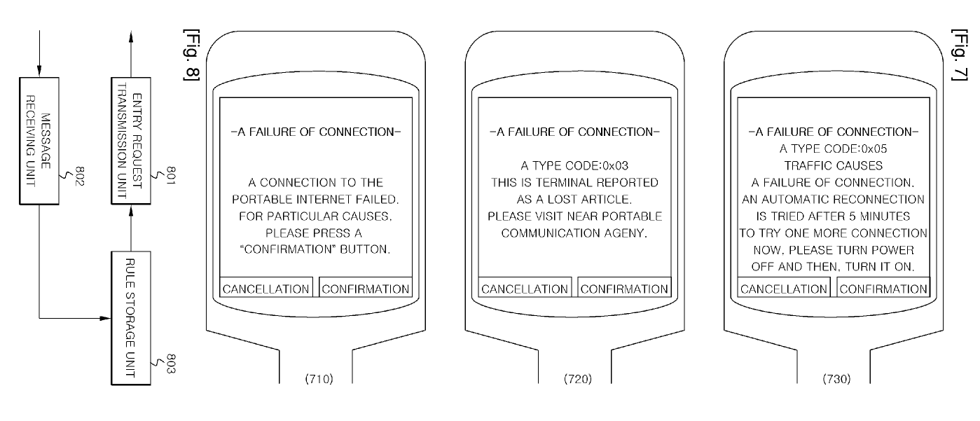

FIG. 6 is a block diagram illustrating an internal configuration of the portable internet terminal according to the present embodiment. With reference to FIG. 6, the terminal according to the present invention includes an entry request transmission unit 601, a type reading unit 602, and a rule storage unit 603. Herein, the entry request transmission unit 601 transmits a network entry request for the portable internet network entry. The type reading unit 602 receives a response message in response to the network entry request, and reads network entry restriction type information contained in the response message. The rule storage unit 603 stores network entry operation rules corresponding to the network entry restriction types. The entry request transmission unit 601 refers to the network entry operation rule, and determines if the network entry request is to be transmitted.

The portable internet terminal according to an embodiment illustrated in FIG. 6, as an example, operates in connection with the apparatus for controlling network entry according to an embodiment illustrated in FIG. 5. The apparatus for controlling network entry receives the network entry request transmitted by the terminal, contains a type identifier related to a network entry restriction cause in the network entry request, and transmits the network entry request containing the type identifier to the terminal again. On receiving the network entry request containing the type identifier, the terminal refers to a type identifier value contained in the message, and sets a network entry operation rule responding to a relevant type. Then, the terminal refers to the set operation rule before transmitting a network entry request each time.

In short, the entry request transmission unit 601 executes the network entry request or a network reentry request according to the network entry operation rules stored in the rule storage unit 603. In regard of this, because the contents referring to the operation rule by network entry restriction types described in relation to the embodiments illustrated in FIGS. 2 to 4, is applied in like manner, hereinafter, a detailed description will be omitted.

The terminal according to the present embodiment may further include a display unit for outputting a message by types according to the type identifier contained in the received response message. FIG. 7 is a view illustrating a display screen of the portable internet terminal according to the present embodiment. A screen 710 illustrates a display screen in a case where the terminal cannot enter the network. The next screens displayed when a confirmation button is pressed as indicated in the screen 710, correspond to screens 720 and 730.

The screen 720 corresponds to a message screen provided in the case of a type in which a terminal transmitting a network entry request has been reported as a lost article. Meanwhile, the screen 730 is a message screen corresponding to a network entry restriction type in a case where a link is not harmoniously implemented due to traffic overload in a cell to which the terminal connects. Thus, the terminal according to the present embodiment can display a message to a user by using the type identifier contained in the entry restriction message, which in turn is able to construct an effective User Interface (UI).

In the meantime, an internal configuration of a portable internet terminal according to another embodiment of the present invention is illustrated in FIG. 8. The portable internet terminal according to another embodiment illustrated in FIG. 8 includes an entry request transmission unit 801, a message receiving unit 802, and a rule storage unit 803. Herein, the entry request transmission unit 801 transmits a network entry request in order to attempt to enter a portable internet network. The message receiving unit 802 receives an authentication result of the terminal performed by a system end in responding to the transmitted entry request. The rule storage unit 803 sets a flag value associated with a network entry operation according to the received authentication result, and stores the set flag value. The entry request transmission unit 801 refers to the previously set flag value, and can determine if a future network entry request is to be transmitted. The configuration of the message receiving unit 802 corresponds to that of the type reading unit 602, and because the names of the units are distinctively given in order to clearly describe the embodiments of the present invention, the names do not limit understanding the embodiments of the present invention.

The portable internet terminal according to the embodiment illustrated in FIG. 8 also operates in connection with the apparatus for controlling network entry according to the embodiment illustrated in FIG. 5. The apparatus for controlling network entry receives the network entry request from the terminal, and transmits, to the terminal again, a result of terminal authentication performed in response to the received network entry request. Then, the terminal receives the result of terminal authentication, stores a flag value related to an entry operation of the terminal with reference to the received authentication result, and then sets a network entry operation rule.

The terminal refers to the previously stored flag value following every network entry attempt, and then determines if the network entry will be attempted. The flag value may be simply toggle information such as ‘0’ or ‘1,’ but the flag value can be also expressed with more diversified level values so that more kinds of operations may be implemented besides transmission/no transmission of the network entry requests according to execution modes or the execution context of the terminal.

Also, the rule storage unit 803 can further include a flag resetting means for resetting the set and stored flag values. The flag resetting means performs an operation for resetting the flag value in a case where the portable internet terminal is powered on or powered off, or in a case where handoff is performed as the portable internet terminal moves away physically. Furthermore, the flag resetting means may be used in a case where a flag value set by a user is forced to reset.

Finally, the apparatus for controlling network entry according to an embodiment of the present invention includes a portable internet terminal corresponding to each of those who use the portable internet, a portable internet base station, a portable internet control station, and an authentication server. The portable internet base station receives a network entry request from the portable internet terminal, and then transmits a MAC address of the portable internet terminal to the portable internet control station. The portable internet control station requests the authentication server to perform authentication in regard of the portable internet terminal by using the MAC address. In a case where the authentication performed by the authentication server in response to the authentication performance request is failed, f the portable internet base station transmits an authentication result received from the portable internet control station to the portable internet terminal.

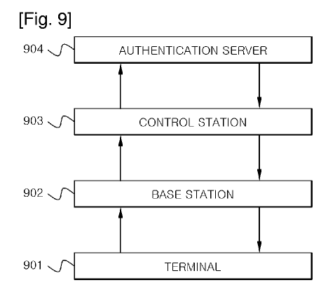

FIG. 9 is a block diagram illustrating a configuration and message flow among configuration elements of a system for controlling network entry according to the present embodiment. As illustrated in FIG. 9, a base station 902 receiving a network entry request transmitted by each terminal 901, transfers the request to a control station 903, and the control station 903 transfers the received entry request to an authentication server 904 again. The authentication server 904 performs user authentication or terminal authentication related to the terminal 901 that has transmitted the entry request, and transmits an authentication result to the terminal 901 again via the control station 903 and the base station 902. The terminal 901 stores a flag value related to a network entry operation rule of the terminal with reference to the received authentication result, sets a network entry operation rule, and refers to a set flag value with regard to a subsequent entry operation.

In a case where the flag value is set since the authentication result corresponds to a failed authentication, the terminal stops transmitting a continuous network entry request. If the authentication result corresponds to a successful authentication, it means that the network entry request has already been processed, and then an entry initializing process has been performed. Therefore, it is not necessary for the terminal to transmit the entry request again except for a case where the retransmission of the entry request is needed as in handover and the like.

In a case where the power supply of the terminal is stopped and is then newly applied, a set flag value represents a result related to a last entry attempt. Still, in a case where the power supply of the terminal is newly applied, it is necessary to transmit a new network entry request irrespective of the flag value aside from a special case. However, it is apparent that the flag value can function as a parameter which causes a network entry request transmission operation following the applying of the power supply to partly change according to the last entry attempt result.

Hitherto, in relation to FIGS. 5 to 9, the description has been made of the operation and the configuration of the apparatus for controlling network entry, the portable internet terminal for performing network entry control in connection with the control apparatus, and the system for controlling network entry including the control apparatus and the portable internet terminal, according to the present invention, and hereinafter, a detailed description will be omitted, in that the contents aforementioned in the embodiments illustrated in FIGS. 2 to 4 can be applied to the present embodiments in a like manner.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A method for controlling entry of a portable internet terminal into a portable internet network, the method comprising the steps of:
receiving an network entry request for entry into the portable internet network from the portable internet terminal;
determining if the portable internet terminal can enter the portable internet network in response to the network entry request; and
generating a network entry restriction message according to an entry restriction type in a case where the portable internet terminal cannot entry the portable internet network as a result of the determining, and transmitting the network entry restriction message to the portable internet terminal to be set a network entry operation rule by the portable internet terminal.

2. The method as claimed in claim 1, wherein the network entry restriction message contains a type identifier corresponding to an entry restriction type of the portable internet terminal, and the network entry operation rule corresponding to a network entry operation is set by the portable internet terminal with reference to the type identifier.

3. The method as claimed in claim 1, wherein the network entry restriction message comprises:
a message type field for storing a message type identifier to distinguish the network entry restriction message from other kinds of messages;
a Media Access Control (MAC) address field for storing the MAC address of the portable internet terminal; and
a type identifier field for storing a type identifier corresponding to the entry restriction type of the portable internet terminal.

4. The method as claimed in claim 1, wherein the network entry restriction message conforms to the IEEE 802.16d/e standards.

5. The method as claimed in claim 1, wherein the entry restriction type comprises any of:
a first type in which authentication of the potable internet terminal is failed;
a second type in which the portable internet terminal is not registered;
a third type in which the portable internet terminal is a type of prepayment, and the prepayment is exhausted;
a fourth type in which the portable internet terminal is reported as a lost article;
a fifth type in which MAC addresses of the portable internet terminals are duplicated; and
a sixth type in which traffic of the portable internet network is overloaded

6. The method as claimed in claim 5, wherein the network entry operation rule is to prohibit a network reentry request while the portable internet terminal is powered on in a case where the entry restriction type corresponds to any of the first to third types.

7. The method as claimed in claim 5, wherein the network entry operation rule is to prohibit a network reentry request while the portable internet terminal is powered on, and to provide at least one among information of terminal identification number, information of base station number, and information of time when the network entry request is received on in a case where the entry restriction type corresponds to either the fourth type or the fifth type.

8. The method as claimed in claim 5, wherein the network entry operation rule is to request a network reentry after a set time passes in a case where the entry restriction type corresponds to the sixth type.

9. The method as claimed in claim 5, which further comprises discontinuing a portable internet service provided to the portable internet terminal in a case where the entry restriction type corresponds to the third type.

10. The method as claimed in claim 1, wherein the network entry operation rule is to display a message by types representing entry restriction types of the portable internet terminal.

11. The method as claimed in claim 1, wherein the network entry operation rule is to store a flag value related to the network entry operation in a case where the entry restriction type is the authentication result of the portable internet terminal.

12. The method as claimed in claim 11, wherein the network entry operation rule is to prohibit a network reentry request of the portable internet terminal while the portable internet terminal is powered on in a case where the flag value is stored.

13. The method as claimed in claim 11, wherein the entry restriction message corresponds to a response message in accordance with Privacy Key Management (PKM) protocol.

14. Recording media, which can be read by a computer, having programs required to run the method as claimed in claim 1, stored therein.

15. An apparatus for controlling entry of a portable internet terminal into a portable internet network, the apparatus comprising:
an entry request receiving unit for receiving a network entry request from the portable internet terminal;
an entry determining unit for determining if the portable internet terminal can enter the portable internet network; and
a message transmission unit for generating a network entry restriction message in a case where the entry determining unit determines that the portable internet terminal cannot enter the network, and for transmitting the generated network entry restriction message to the portable internet terminal,
wherein the network entry restriction message is received by the portable internet terminal, and is used in setting a network entry operation rule of the portable internet terminal.

16. The apparatus as claimed in claim 15, wherein the network entry restriction message contains a type identifier corresponding to an entry restriction type of the portable internet terminal, and the network entry operation rule corresponding to a network entry operation is set by the portable internet terminal with reference to the type identifier.

17. The apparatus as claimed in claim 15, wherein the entry determining unit determines if the entry into the network can be approved, with reference to at least one among a Media Access Control (MAC) address of the portable internet terminal, information of the portable internet terminal identification number, subscriber information related to the portable internet terminal, information on a base station to which the portable internet terminal is accessed, whether the portable internet terminal corresponds to a type of prepayment, and whether the prepayment is exhausted.

18. The apparatus as claimed in claim 15, wherein the network entry restriction message contains an authentication result of the portable internet terminal, and the network entry operation rule is to store a flag value corresponds to network entry restriction.

19. The apparatus as claimed in claim 15, wherein the network entry restriction message comprises:
a message type field for storing a message type identifier to distinguish the network entry restriction message from other kinds of messages;
a Media Access Control (MAC) address field for storing the MAC address of the portable internet terminal; and
a type identifier field for storing a type identifier corresponding to the entry restriction type of the portable internet terminal.

20. The apparatus as claimed in claim 15, wherein the network entry restriction message conforms to the IEEE 802.16d/e standards.

21. A portable internet terminal, comprising:
an entry request transmission unit for transmitting a network entry request to access to a portable internet network;
a type reading unit for receiving a response message containing a type identifier in responding to the network entry request, and for reading the type identifier containing a network entry restriction type of the portable network terminal; and
a rule storage unit for storing a network entry operation rule corresponding to the type identifier,
wherein the entry request transmission unit executes the network entry request or a network reentry request according to the network entry operation rules stored in the rule storage unit.

22. The portable internet terminal as claimed in claim 21, which further comprises a display unit for outputting a message by types according to the type identifier contained in the received response message.

23. The portable internet terminal as claimed in claim 21, wherein the type identifier comprises any of:
a first type in which authentication of the potable internet terminal is failed;
a second type in which the portable internet terminal is not registered;
a third type in which the portable internet terminal is a type of prepayment, and the prepayment is exhausted;
a fourth type in which the portable internet terminal is reported as a lost article;
a fifth type in which MAC addresses of the portable internet terminals are duplicated; and
a sixth type in which traffic of the portable internet network is overloaded.

24. The portable internet terminal as claimed in claim 23, wherein the network entry operation rule is to prohibit a network reentry request while the portable internet terminal is powered on in a case where the entry restriction type corresponds to any of the first to third types.

25. The portable internet terminal as claimed in claim 23, wherein the network entry operation rule is to prohibit a network reentry request while the portable internet terminal is powered on, and to provide at least one among information of terminal identification number, information of base station number, and information of time when the network entry request is received on in a case where the entry restriction type corresponds to either the fourth type or the fifth type.

26. The portable internet terminal as claimed in claim 23, wherein the network entry operation rule is to request a network reentry after a set time passes in a case where the entry restriction type corresponds to the sixth type.

27. The portable internet terminal as claimed in claim 21, wherein the network entry operation rule is to store a flag value with regard to the network entry operation referring to a result of authentication for the portable internet terminal in a case where the entry restriction type corresponds to the result of authentication.

28. The portable internet terminal as claimed in claim 27, wherein the network entry operation rule is to cancel the flag value in a case where the portable internet terminal is powered on or powered off, or in a case where handoff is performed as the portable internet terminal moves away physically.

29. A system for controlling entry of a portable internet terminal into a portable internet network, the system comprising:
a portable internet terminal, linked via the portable internet network, for accessing to a base station, a control station, and an authentication server,
wherein the portable internet base station for receiving a network entry request from the portable internet terminal, and for transmitting a Media Access Control (MAC) address of the portable internet terminal to the control station;
the control station for requesting the authentication server to perform authentication in regard of the portable internet terminal by using the received MAC address; and
the authentication server for performing the authentication in response to the authentication performance request from the control station,
wherein the base station transmits an authentication result to the portable internet terminal in a case where the authentication fails.

30. The system as claimed in claim 29, wherein the portable internet terminal refers to the authentication result, and then determines if the network entry request is to be transmitted.
